(19) United States
(12) Patent Application Publication
(10) Pub. No.: US 2003/0230023 A1
(43) Pub. Date: Dec. 18, 2003

(54) Rod rest

(76) Inventor: Pang-Chou Lu, Changhua (TW)

Correspondence Address: BROWDY AND NEIMARK, P.L.L.C., 624 NINTH STREET, NW, SUITE 300, WASHINGTON, DC, 20001-5303, US

(21) Appl. No.: 10/173,112

(22) Filed: Jun. 18, 2002

(51) Int. Cl. A01K 97/10

(52) U.S. Cl. 43/21.2

(57) ABSTRACT

A rod rest is constructed to include a mounting shaft, the mounting shaft having an endpiece and a hook respectively extended from two ends of a shaft body thereof, a tension clamp threaded into a screw hole in the endpiece and adapted for securing the mounting shaft to a fixed object, a swivel member pivoted to an outer side of the shaft body of the mounting shaft for revolution, the swivel member having equally spaced peripheral notches, a rack mounted on the swivel member and adapted for supporting a fishing rod, a shaft tip outwardly extended from the shaft body of the mounting shaft, a hollow retaining pin sleeved onto the shaft tip and movable along the shaft tip between tow positions to lock/unlock the swivel member, and spring means mounted on the shaft tip and connected between the shaft tip and the retaining tip to hold the retaining tip in the locking position.

### BACKGROUND OF THE INVENTION

1. Field of the Invention

The present invention relates to fishing implement, and more specifically, to a rod rest for supporting a fishing rod during fishing.

2. Description of the Related Art

When fishing, the fisher may install a rod rest in the boat or the handrail around the fishing pool to support the fishing rod, so that the fisher needs not to hold the fishing rod all the time when fishing.

FIG. 1 shows a rod rest according to the prior art. According to this design, the rod rest comprises a mounting barrel 1, a swivel block 2 pivoted to the front side of the mounting barrel 1 and turned leftwards/rightwards to the desired angle, two screw bolts 3 bilaterally fastened to the mounting barrel 1 and adapted to limit the turning angle of the swivel block 2 relative to the mounting barrel 1, a receiving tube 4 pivoted to the front side of the swivel block 2 and turned upwards/downwards to the desired angle, a lock screw 5 adapted for locking the receiving tube 4, and a tightening up screw 6 adapted for locking the fishing rod after insertion of the fishing rod into the receiving tube 4. This structure of rod rest is not convenient in use. When the fishing rod inserted into the receiving tube 4, the tightening up screw 6 must be fastened tight to fix the fishing rod in position. When adjusting the tilting angle of the fishing rod, the user must loosen the lock screw 5, and then turn the receiving tube 4 relative to the swivel block 2 to the desired angle, and then fasten up the lock screw 5 again. Further, the mounting barrel 1 is adapted for mounting on a protruded member or the end of a rod member. It cannot be fastened to a mid part of a handrail or rod member.

### SUMMARY OF THE INVENTION

It is one object of the present invention to provide a rod rest, which can easily stably fastened to a fixed object for supporting a fishing rod during fishing.

It is another object of the present invention to provide a rod rest, which has a simple structure and, is convenient to operate.

To achieve these objects of the present invention, the rod rest comprises a mounting shaft having a shaft body, an endpiece extended from one end of the shaft body, and a hook extended from an opposite end of the shaft body and suspended above the endpiece, the endpiece having screw hole; a tension clamp adapted for securing the mounting shaft to a fixed object; a swivel member pivoted to an outer side of the shaft body of the mounting shaft for revolution, the swivel member having a plurality of peripheral notches spaced around the periphery thereof; a rack mounted on the swivel member and adapted for supporting a fishing rod and keeping the supported fishing rod in direction substantially perpendicular to the axis of the swivel member; a shaft tip outwardly extended from the shaft body of the mounting shaft adjacent to the swivel member; a hollow retaining pin sleeved onto the shaft tip and movable along the shaft tip between a first position where the retaining pin is disposed in engagement with one peripheral notch of the swivel member to stop the swivel member from rotary motion and a second position where the retaining pin is disengaged from the periphery notches of the swivel member for enabling the swivel member to be rotated; and spring means mounted on the shaft tip and connected between the shaft tip and the retaining pin to hold the retaining pin in the first position.

### BRIEF DESCRIPTION OF THE DRAWINGS

FIG. 1 is an exploded view of a rod rest according to the prior art.

FIG. 2 is an exploded view of a rod rest according to the present invention.

FIG. 3 is an assembly view of the rod rest according to the present invention.

FIG. 4 is an applied view of the present invention, showing the rod rest installed in a vertical round bar.

FIG. 5 is a rear side view of the present invention corresponding to the application status shown in FIG. 4.

FIG. 6 is a sectional view taken along line 6-6 of FIG. 5.

FIG. 7 is similar to FIG. 6 but showing the retaining pin disengaged from the periphery notches of the swivel member.

FIG. 8 is an applied view of the present invention, showing the rod rest installed in a transverse bar.

### DETAILED DESCRIPTION OF THE PREFERRED EMBODIMENT

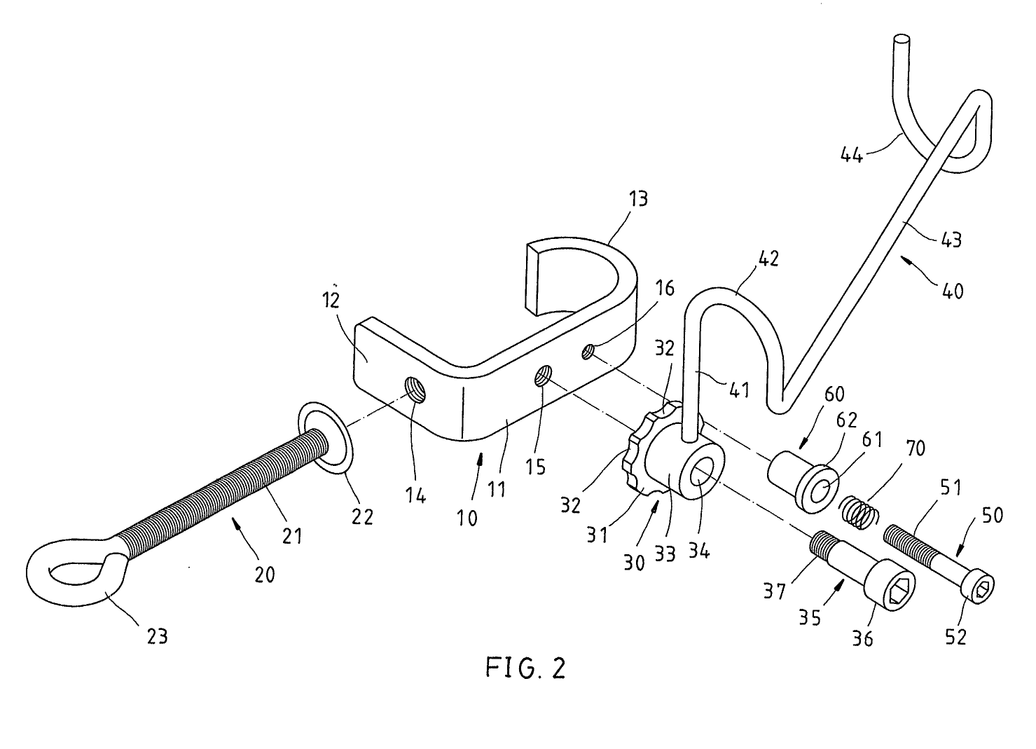

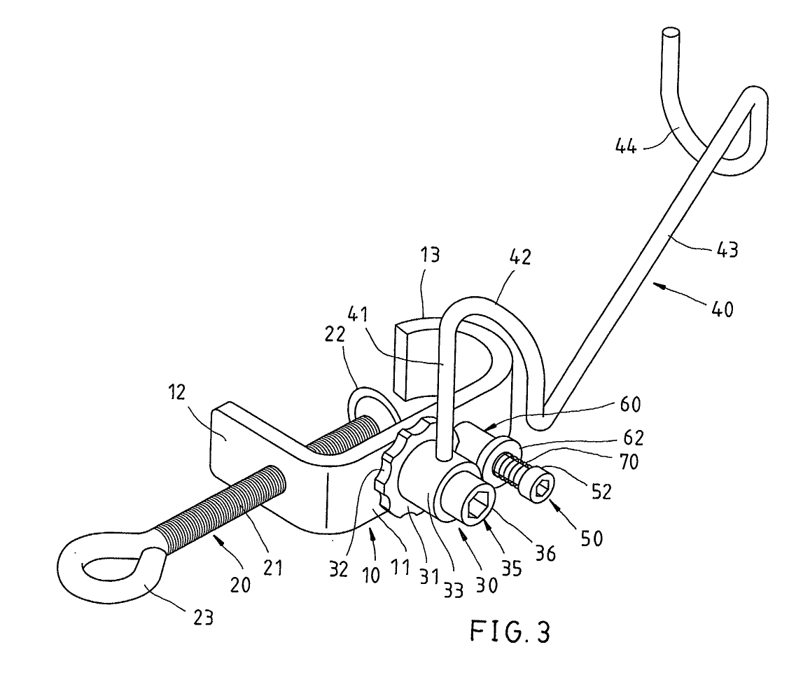

Referring to FIGS. 2 and 3, a rod rest in accordance with the present invention is shown comprised of a mounting shaft 10, a tension clamp 20, a swivel member 30, a pivot 35, a rack 40, a shaft tip 50, a retaining pin 60, and a spring 70.

The mounting shaft 10 is made of a flat metal bar comprising a longitudinal shaft body 11, an endpiece 12 extended one end, namely, the rear end of the longitudinal shaft body 11 at right angles, a hook 13 extended from the other end, namely, the front end of the longitudinal shaft body 11 and suspended above the endpiece 12, a first screw hole 14 extended through the center of the endpiece 12 and axially aimed at the center of the hook 13, and a second screw hole 15 and a third screw hole 16 transversely extended through the shaft body 11. The hook 13 is smoothly arched, having the inner side curved inwards and facing the endpiece 12.

The tension clamp 20 comprises a metal screw rod 21 threaded into the first screw hole 14 of the endpiece 12 of the mounting shaft 10, a disk-like clamping plate 22 riveted to one end, namely, the inner end of the screw rod 21 and facing the hook 13, and a handle 23 integral with the other end, namely, the outer end of the screw rod 21 outside the mounting shaft 10. Through the handle 23, the user can rotate the tension clamp 20 in the first screw hole 14 of the endpiece 12 of the mounting shaft 10 to move the disk-like clamping plate 22 relative to the hook 13, i.e., to adjust the pitch between the disk-like clamping plate 22 and the hook 13.

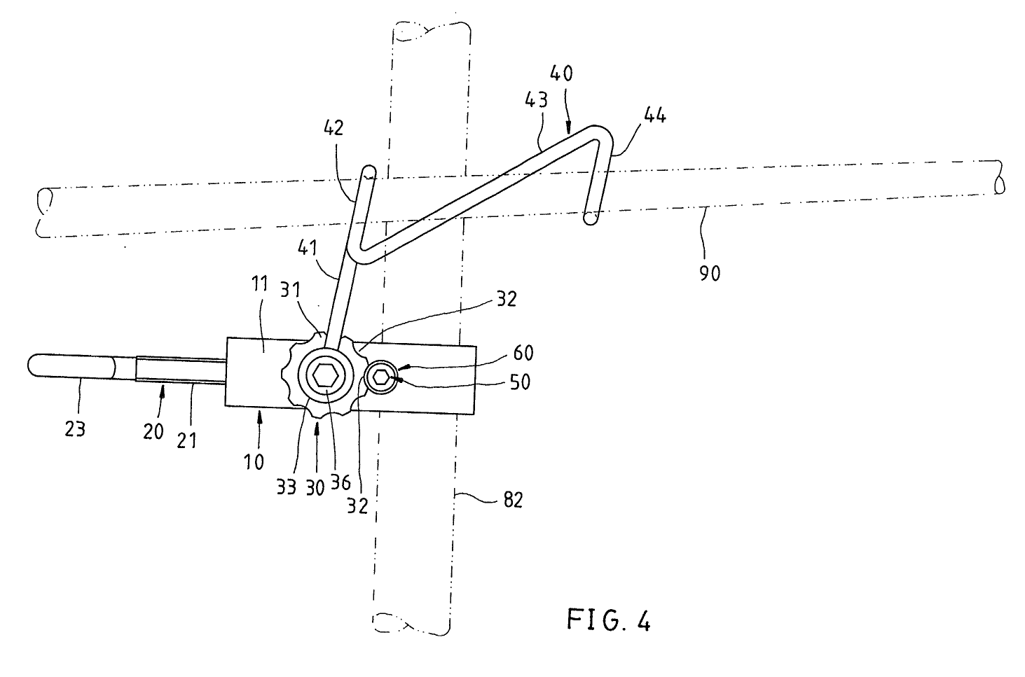

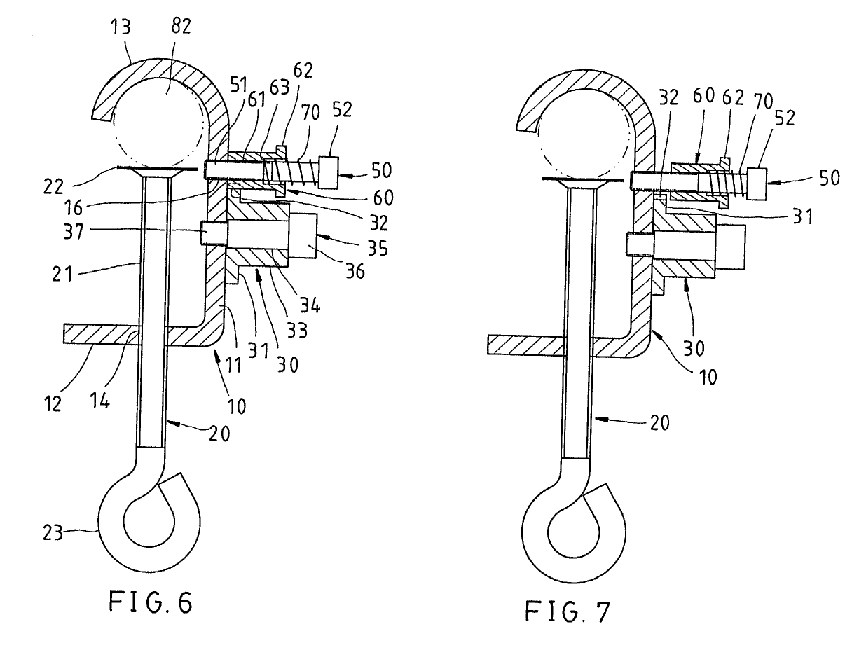

The swivel member 30 is a metal member comprising a wheel body 31 and a shaft 33 perpendicularly extended from one side of the wheel body 31 at the center, and an axle hole 34 axially extended through the axis of the shaft 33 and the center of the wheel body 31 (see also FIG. 6). The wheel body 31 is shaped like a gear (see also FIG. 4), having a plurality of smoothly arched peripheral notches 32 equiangularly spaced around the periphery (there are nine peripheral notches 32 equally spaced from one another at 40°). The pivot 35 is inserted through the axle hole 34 of the swivel member 30, having a head 36 disposed at one end and slightly stopped at the outer end of the shaft 33 remote from the wheel body 31, and a threaded mounting portion 37 axially disposed at the other end and threaded into the second screw hole 15 of the mounting shaft 10. After installation of the pivot 35, the swivel member 30 can be turned about the pivot 35 to the desired angle.

The rack 40 is made of a metal wire rod comprising a mounting portion 41 disposed at one end and welded to the periphery of the shaft 33 of the swivel member 30, a supporting portion 44 disposed at the other end, a holding down portion 42 connected between the mounting portion 41 and the supporting portion 44, and an extension portion 43 connected between the supporting portion 44 and the holding down portion 42. The mounting portion 41 is a straight rod section perpendicularly extended from the periphery of the shaft 33 of the swivel member 30. The holding down portion 42 extends from one end of the mounting portion 41 remote from the shaft 33 of the swivel member 30, and curves in direction toward the swivel member 30, defining with the mounting portion 41 a substantially semi-circular opening. The extension portion 43 is straightly extended from one end of the holding down portion 42 remote from the mounting portion 41 at an angle about 45° relative to the mounting portion 41 (see FIG. 4). The supporting portion 44 extends from one end of the extension portion 43 remote from the holding down portion 42, and curves in direction reverse to the holding down portion 42.

The shaft tip 50 is provided on the outer side of the shaft body 11 of the mounting shaft 10. According to the present preferred embodiment, the shaft tip 50 is a screw bolt, having the threaded rod 51 threaded into the third screw hole 16 of the mounting shaft 10 and the head 52 disposed outside the mounting shaft 10.

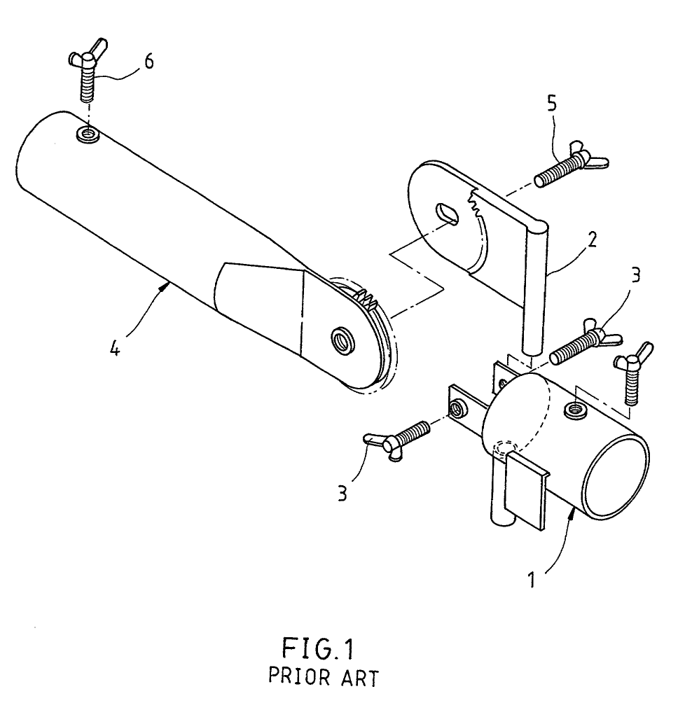

The retaining pin 60 is a metal hollow pin sleeved onto the shaft tip 50 and moved along the shaft tip 50 between the first position shown in FIG. 1 and the second position shown in FIG. 7. The outer diameter of the retaining pin 60 fits the curvature of the peripheral notches 32 of the swivel member 30. When the retaining pin 60 moved to the first position, it is engaged into one peripheral notch 32 of the swivel member 30 to stop the rotary member 30 from rotation. When the retaining pin 60 is moved to the second position, it is disengaged from the peripheral notches 32 of the swivel member 30, enabling the swivel member 30 to be turned about the pivot 35 to the desired angle. The retaining pin 60 comprises an axial center through hole 61, which receives the shaft tip 50, an outside flange 62 extended around the periphery of one end thereof remote from the mounting shaft 10, and an inside annular flange 63 concentrically disposed inside the axial center through hole 61 around the periphery of the shaft tip 50 (see FIG. 6).

The spring 70 is mounted on the shaft tip 50 and stopped between the inside annular flange 63 of the retaining pin 60 and the head 52 of the shaft tip 50. The spring 70 holds the retaining pin 60 in the first position when receiving no pressure.

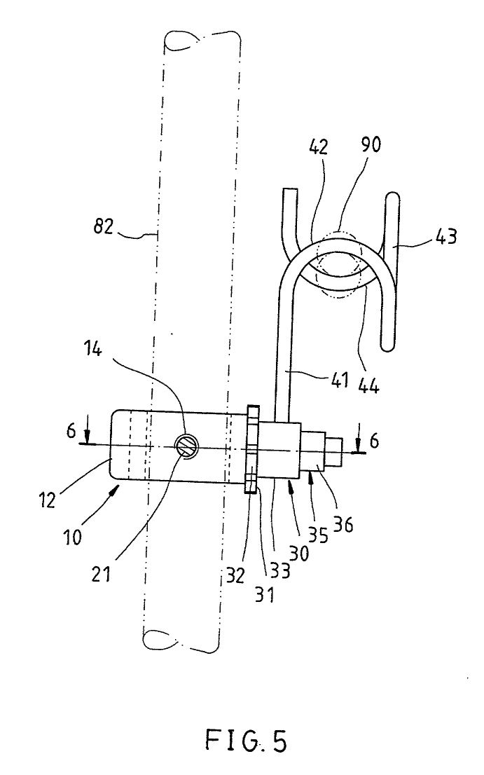

The use of the rod rest is outlined hereinafter. When installing the rod rest in, for example, a vertical round bar 82, as shown in FIGS. 4, 5, and 6, the hook 13 of the mounting shaft 10 is hooked on the round bar 82, and then the tension clamp 20 is rotated inwards to force the disk-like clamping plate 22 against the periphery of the round bar 82, enabling the rod rest to be stably fastened to the round bar at the desired elevation. Thereafter, the retaining pin 60 is pulled outwards to the second position (see FIG. 7) to unlock the swivel member 30, and then the rack 40 is turned with the swivel member 30 about the pivot 35 to the desired angle, and then the retaining pin 60 is released from the hand and forced by the spring 70 into engagement with the peripheral notches 32 of the swivel member 30 to lock the swivel member 30 and the rack 40 in the desired angle. When pulling the retaining pin 60 from the first position to the second position, rest the thumb on the head 52 of the shaft tip 50, and then pull the outside flange 62 of the retaining pin 60 outwards with the forefinger and the middle finger. After installation of the rod rest, the fishing rod 90 can then be rested on the rod rest, keeping a front part of the fishing rod 90 supported on the supporting portion 44 of the rack 40 and a rear part of the fishing rod 90 held down by the holding down portion 42 of the rack 40.

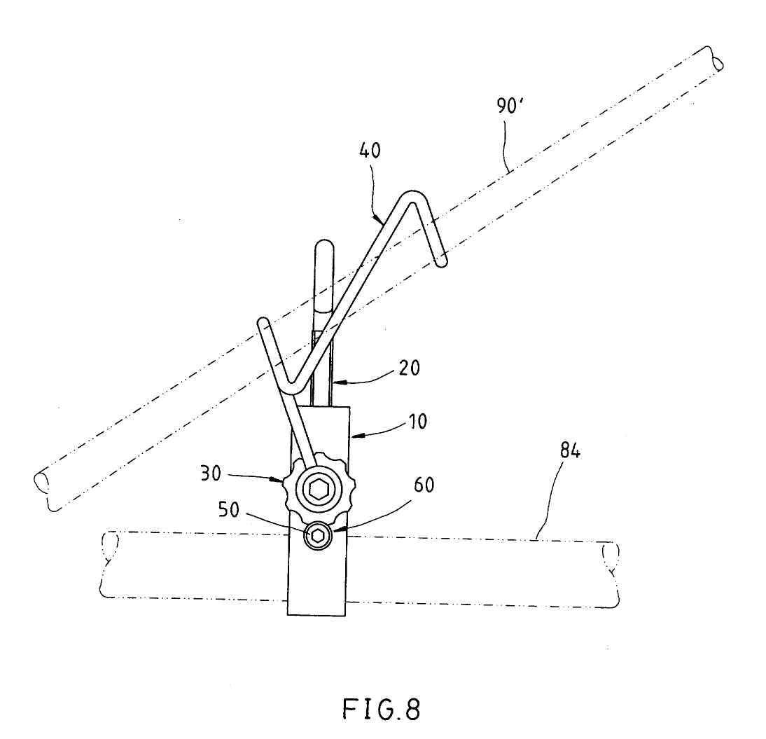

Referring to FIG. 8, the rod rest can be fastened to a horizontal bar 84 in the same way. Of course, the rod rest can also be easily fastened to an obliquely extended rod member or a protruding member.

What the invention claimed is:

1. A rod rest comprising,
a mounting shaft having a shaft body, an endpiece extended from one end of said shaft body, and a hook extended from an opposite end of said shaft body and suspended above said endpiece, said endpiece having a screw hole;
a tension clamp having a screw rod threaded into the screw hole of said endpiece of said mounting shaft, a clamping plate disposed at one end of said screw rod and moved with said screw rod between said hook and said endpiece, and a handle disposed at an opposite end of said screw rod outside said mounting shaft;
a swivel member pivoted to an outer side of said shaft body of said mounting shaft for revolution, said swivel member having a plurality of peripheral notches spaced around the periphery thereof;
a rack mounted on said swivel member and adapted for supporting a fishing rod and keeping the supported fishing rod in direction substantially perpendicular to the axis of said swivel member;
a shaft tip outwardly extended from said shaft body of said mounting shaft adjacent to said swivel member;
a hollow retaining pin sleeved onto said shaft tip and movable along said shaft tip between a first position where said retaining pin is disposed in engagement with one peripheral notch of said swivel member to stop said swivel member from rotary motion and a second position where said retaining pin is disengaged from the periphery notches of said swivel member for enabling said swivel member to be rotated; and
spring means mounted on said shaft tip and connected between said shaft tip and said retaining pin to hold said retaining pin in said first position.

2. The rod rest as claimed in claim 1, wherein said shaft body of said mounting shaft is an elongated flat member having a first end and a second end; said endpiece is a flat member perpendicularly extended from the first end of said shaft body of said mounting shaft; said hook of said mounting shaft is smoothly arched and extended from the second end of said shaft body of said mounting shaft, having an inner side curved inwards and facing said endpiece; the screw hole of said endpiece of said mounting shaft is aimed at the center of said hook.

3. The rod rest as claimed in claim 1, wherein said clamping plate of said tension clamp is a disk-like plate member facing said hook; said handle of said tension clamp is shaped like a split ring formed integral with one end of said screw rod of said tension clamp remote from said clamping plate.

4. The rod rest as claimed in claim 1, wherein said swivel member comprises a wheel body disposed in contact with said shaft body of said mounting shaft, a shaft perpendicularly extended from one side of said wheel body opposite to said shaft body of said mounting shaft, an axle hole axially extended through the shaft of said swivel member and the center of said wheel body, and a pivot inserted through said axle hole and fastened to said shaft body of said mounting shaft for enabling said wheel body to be rotated on said pivot, said pivot having a head stopped outside the shaft of said swivel member; said peripheral notches of said swivel member are formed in and equiangularly spaced around the periphery of said wheel body; said rack has one end fixedly connected to the periphery of the shaft of said swivel member; said hollow retaining pin has an outer diameter fitting the curvature of said peripheral notches, and an inner end, which is engaged into one peripheral notch of said swivel member when said hollow retaining pin is moved to said first position or disengaged from the peripheral notches of said swivel member when said hollow retaining pin is moved to said second position.

5. The rod rest as claimed in claim 1, wherein said rack is made of a metal wire rod comprising a mounting portion disposed at one end and fixedly connected to and radially outwardly extended from the periphery of said swivel member, a holding down portion extended from one end of said mounting portion remote from said swivel member and curved in direction toward said swivel member and defining with said mounting portion a substantially semi-circular opening, an extension portion extended from one end of said holding down portion remote from said mounting portion in direction apart from said swivel member, and a supporting portion extended from one end of said extension portion remote from said holding down portion and curved in direction reverse to said holding down portion.

6. The rod rest as claimed in claim 1, wherein said shaft tip is a screw bolt having a head disposed at one end thereof; said hollow retaining pin comprising an outward flange extended around the periphery of one end thereof remote from said mounting shaft and an inside annular flange disposed around said shaft tip; said spring is mounted on said shaft tip and stopped between the head of said shaft tip and the inside annular flange of said hollow retaining pin.
